(19) United States
(12) Patent Application Publication
(10) Pub. No.: US 2018/0149079 A1
(43) Pub. Date: May 31, 2018

(54) SPARK-IGNITION ENGINE WITH SUBSEQUENT CYLINDERS

(71) Applicant: Gerd Bauer, Chappaqua, NY (US)

(72) Inventor: Gerd Bauer, Chappaqua, NY (US)

(21) Appl. No.: 15/821,878

(22) Filed: Nov. 24, 2017

(30) Foreign Application Priority Data
Nov. 28, 2016 (DE) 102016122855.9

(51) Int. Cl. F02B 41/06; F02B 33/22; F02B 29/04; F02B 33/44

(52) U.S. Cl. CPC F02B 41/06; F02B 33/22; F02B 2075/025; F02B 33/44; F02B 29/0406

(57) ABSTRACT

The present invention concerns an engine comprising at least one working cylinder (1) which has valves (16) and/or nozzles for the feed or injection of fuel and air and for the outlet of exhaust gas and a method of operating such an engine. In order to provide an engine and a corresponding method by which the fuel is used considerably more efficiently without excessively high temperatures occurring, which entail the risk of misfires, it is proposed according to the invention that each working cylinder (1) is coupled to a subsequent cylinder (11) which is driven by the pressure of hot exhaust gases from the working cylinder (1) and which is so designed and arranged that on the other hand it feeds pre-compressed combustion air to the working cylinder (1), a cooling device (17) which cools the pre-compressed gas, a device (9, 7) for transferring the cooled pre-compressed gas into the working cylinder (1) and a transfer valve (16) which for a further stroke of the subsequent cylinder (1) transfers exhaust gas under pressure from the working cylinder (1) into the subsequent cylinder (11).

The present invention concerns an internal combustion engine in the form of an engine having a number of working cylinders which have valves and/or nozzles for the feed or injection of fuel and air and for the outlet of exhaust gas. Such an engine is known in particular in the form of the conventional spark-ignition engine and in particular as an automobile engine.

The invention also concerns a method of operating an engine according to the invention.

A disadvantage of almost all internal combustion engines and in particular the spark-ignition engine lies in the only very mediocre conversion of the introduced energy into kinetic energy. Typically a spark-ignition engine converts between about 10 and 20 percent of the introduced chemical energy into mechanical propulsion energy. The greatest part of the energy introduced is lost in the form of waste heat and by virtue of unused discharge of the residual pressure of the exhaust gas expelled from the engine cylinder.

The low level of efficiency of spark-ignition engines is linked inter alia to a relatively low compression ratio for the air-fuel mixture and the maximum toleratable temperatures as well as incomplete combustion of the fuel in the working stroke.

It is however not readily possible to increase the compression ratio because then the temperatures in the cylinder also correspondingly rise and there is the risk of uncontrolled misfires which can result in an engine being ruined within a short time.

Therefore the object of the invention is to provide an engine and a method of operating same, or to modify same in such a way that the fuel is used considerably more efficiently without excessively high temperatures occurring, which entail the risk of misfires.

In regard to the engine that object is attained in that each working cylinder of the engine is coupled to a subsequent cylinder which is driven by a partial combustion and by the residual pressure of incompletely burnt hot exhaust gases from the working cylinder and which on the other hand feeds pre-compressed combustion air to the working cylinder, a cooling device which cools the pre-compressed gas, a device for transferring the cooled pre-compressed gas into the working cylinder and a transfer valve which for a further stroke of the subsequent cylinder transfers exhaust gas under pressure into the subsequent cylinder.

According to the invention therefore the engine has at least two cylinders, namely a working cylinder which substantially corresponds to a conventional cylinder and a subsequent cylinder which effectively represents an enlargement of the working cylinder as on the one hand it already provides for pre-compression of the combustion air and on the other hand it also serves as an expansion chamber for incompletely burnt working gas (mixture of exhaust gas and incompletely burnt combustion gas) from the working cylinder so that, by virtue of the increased expansion, the working gas can be substantially better cooled down and relieved of pressure, wherein the pressure of the exhaust gas from the working cylinder until the outlet of the subsequent cylinder can be drastically reduced in comparison with the residual pressure in the cylinder of conventional engines. The exhaust gas therefore involves a lower residual pressure and also a lower temperature, which necessarily entails more effective use of the fuel.

The effective compression ratio is already substantially higher than in a conventional engine as the combustion air fed to the working cylinder, possibly also a mixture of combustion air and fuel, is already pre-compressed by the subsequent cylinder, but is cooled before being transferred into the working cylinder so that, even with mediocre further compression, a critical temperature limit is not exceeded. At the same time however the effective compression ratio is increased as it is the product of the compression ratios of the subsequent cylinder and the working cylinder. With a compression ratio for the subsequent cylinder of 3 and a compression ratio of the working cylinder of 8, this gives as the effective compression ratio a value of 24 which cannot be achieved with conventional engines, but in the case of the engine according to the invention is made possible by virtue of pre-compression in the subsequent cylinder and then cooling before transfer into the working cylinder.

The method according to the invention is accordingly characterised by the use of an engine of the above-described kind, in which in a first stroke of a subsequent cylinder ambient air is drawn in, said air is compressed in a second stroke of the subsequent cylinder and after intercooling is transferred to the working cylinder, wherein after the corresponding compression and working strokes of the working cylinder the working gas of the working cylinder, which is under residual pressure and has not been completely burnt, is transferred to the subsequent cylinder, wherein the subsequent cylinder in turn in a third stroke receives the hot exhaust gas and relieves its pressure and the subsequent cylinder in a fourth stroke ejects the exhaust gas at a reduced residual pressure.

Various measures are conceivable for further increasing the efficiency of the engine. On the one hand it is appropriate if the subsequent cylinder is of a larger volume than the working cylinder, wherein the volume of the subsequent cylinder is preferably between 1.2 and 4 times the volume of the working cylinder. That permits relief of the pressure of the working gas to a residual pressure in the region of the ambient pressure, in particular if the volume of the fresh air drawn in by the subsequent cylinder is limited and is less than the volume of the subsequent cylinder at bottom dead center.

In addition the compression ratio of the subsequent cylinder in preferred embodiments is between 2 and 5.

As already mentioned there is also provided a cooling device for pre-compressed gas, desirably disposed between the outlet of the subsequent cylinder and the corresponding inlet of the working cylinder.

In addition an inverse turbine can also be disposed downstream of the subsequent cylinder, more specifically with an inlet stage for expansion below the ambient pressure, an intercooler connected downstream of the inlet stage (which is required to attain the lower pressure at the end of the inlet stage), with a subsequent compression stage for concluding compression to ambient pressure.

Accordingly in a stroke for pre-compression of combustion air the subsequent cylinder is disposed upstream of the working cylinder and for a working stroke it is disposed downstream of the working cylinder so that the completely burnt exhaust gas is thereafter ejected from the subsequent cylinder and from there can be transferred into an inverse turbine.

In a further embodiment the engine additionally has an exhaust gas recirculation means.

The engine can be in particular in the form of a four-cylinder engine having respectively four working cylinders and four subsequent cylinders and with two crankshafts of which one is associated with the working cylinders and the other with the subsequent cylinders, wherein desirably the crankshafts are coupled together and are preferably adjustably coupled together so that the relative angle between the top dead centers of the working cylinders and the subsequent cylinders can be altered. The connection of all cylinders to a common crankshaft would also be conceivable, which however would fix the angular displacement between working cylinder and subsequent cylinder, which when using two separate and adjustably coupled crankshafts, could be variably adjustable and under some circumstances also dynamically variably adjustable.

The compression ratio of the working cylinder should desirably be between 5 and 10, thereby affording the above-described increased effective compression ratio as the combustion air fed to the working cylinder is already pre-compressed by a factor of between 2 and 5.

In an embodiment the cylinders are arranged in a V-shape, wherein one bank of the V-shape is formed by the working cylinders and the other bank of the V-shape is formed by the subsequent cylinders. This variant is advantageous in particular in the case of a higher pre-compression because, with higher pre-compression, the subsequent cylinder is of a comparable size to the working cylinder.

In an embodiment the subsequent cylinder or cylinders are in the form of 4-stroke cylinders. Then a respective working cylinder has a subsequent cylinder associated therewith, which has working strokes that are displaced in relation to the working cylinder and both implements pre-compression for the combustion air fed to the working cylinder and also receives the exhaust gas which has not yet been completely burnt as its working gas from the working cylinder.

In another variant the subsequent cylinder or cylinders can be in the form of 2-stroke cylinders, wherein the number of subsequent cylinders is half the number of the working cylinders and each subsequent cylinder is associated with two different working cylinders, the working strokes of which are displaced relative to each other substantially through 180°. In that case the subsequent cylinder operates synchronously relative to the working cylinders just as in the case of 4-strokes, but requires only half as many strokes (namely 2) for a cycle of pre-compression and (residual) combustion and can thus function in 4 (2×2) strokes in succession for two working cylinders as a subsequent cylinder.

In all variants it is preferred for the parameters to be so selected that the expansion volume in all is larger than the volume of the fresh air which is sucked in. That can be achieved for example by premature closure of an inlet valve for the subsequent cylinder.

In regard to the method according to the invention the parameters of the engine are desirably so set that the reduced residual pressure at the outlet of the subsequent cylinder approximately corresponds to the ambient pressure. The residual pressure at the outlet of the subsequent cylinder depends above all on the available volume, the compression ratio, the exhaust gas temperature and the degree of combustion of the gases upon transfer to the subsequent cylinder.

The working cylinder operates substantially like the cylinder of a conventional spark-ignition engine but with the modification that the combustion air passing into the cylinder or optionally combustion air already mixed with fuel is pre-compressed and cooled after or upon pre-compression passes into the working cylinder and is additionally compressed therein in a first stroke of the working cylinder. Thereupon in the next working stroke the gas mixture is fired, which drives the piston of the working cylinder, wherein, also unlike a conventional spark-ignition engine, the exhaust valve of the working cylinder can already be opened at a relatively early time, for example between 30° and 60° after reaching the top dead center of the working cylinder. Accordingly the exhaust gases or the gases which are still burning can then already pass across into the subsequent cylinder in order there to produce further work and drive the piston of the subsequent cylinder, wherein the greater volume of the subsequent cylinder leads to correspondingly great expansion and cooling and correspondingly more complete combustion. The foregoing values in degrees (“° ”) relate to the stroke cycle of a piston and thus also the angular position upon rotation of the crankshaft or crankshafts.

More specifically while combustion of conventional gasoline with air initially occurs at very high temperatures only to give CO and H₂O complete combustion to CO₂ occurs only with a delay and only at a lower temperature below 2000° C., so that in a conventional engine complete combustion to give CO₂ is not achieved in the working cylinder before each expulsion of the exhaust gases. In the engine according to the invention however, by virtue of the greater relief of pressure and cooling, combustion to give CO₂ occurs almost completely and at any event more extensively than is conventionally the case, and the working gas until then produces work not only in the working cylinder but also in the subsequent cylinder.

The waste heat which is then still present of the exhaust gas issuing from the subsequent cylinder can be converted into mechanical work for example by an inverse turbine. The term inverse turbine is used in that respect to denote a turbine whose inlet stage is not a compressor but an expansion stage. That is possible by cooling of the exhaust gas in a intercooler disposed between the inlet stage and the outlet stage of the inverse turbine. By virtue of the cooling action the still hot exhaust gas which passes into the inlet stage of the inverse turbine can be cooled and expanded to a pressure below the ambient pressure so that the subsequent outlet stage of the inverse turbine is in the form of a compressor and compresses the cooled exhaust gas to ambient pressure and then expels it.

In addition the method according to the invention provides for retarded firing or late firing, that is to say firing of the fuel-air mixture occurs only in a region up to 10 degrees, in particular between 20° and 10° before reaching the top dead center of the working cylinder. Because of the delayed heating which is linked thereto in the region after the top dead center, that results in a lower flame temperature and more uniform temperature distribution over the working stroke so that expansion in the working cylinder is substantially isothermal expansion. At the same time that is linked to more efficient combustion which is better distributed over the working stroke and of which a part also occurs in the subsequent cylinder. At very high temperatures the fuel (gasoline) burns to give CO and hydrogen gas. The further combustion stage is combustion to give carbon monoxide and water and it is only in the last stage which can take place only at lower temperatures around 1000 degree and below that complete combustion to give CO₂ and water occurs. The last combustion stage, the use of which involves a higher energy yield, can therefore take place only at correspondingly lower temperatures and the combustible gas must then also still be able to do effectively corresponding work, that is to say it must still be in the working cylinder or in the subsequent cylinder. An angular displacement of between 30° and 60° between the working cylinder and the subsequent cylinder also extends the time of expansion into the subsequent cylinder and gives the above-mentioned more complete energy utilization in respect of the fuel.

Further advantages, features and possible uses of the present invention will be apparent from the description hereinafter of a preferred embodiment and the accompanying Figures in which:

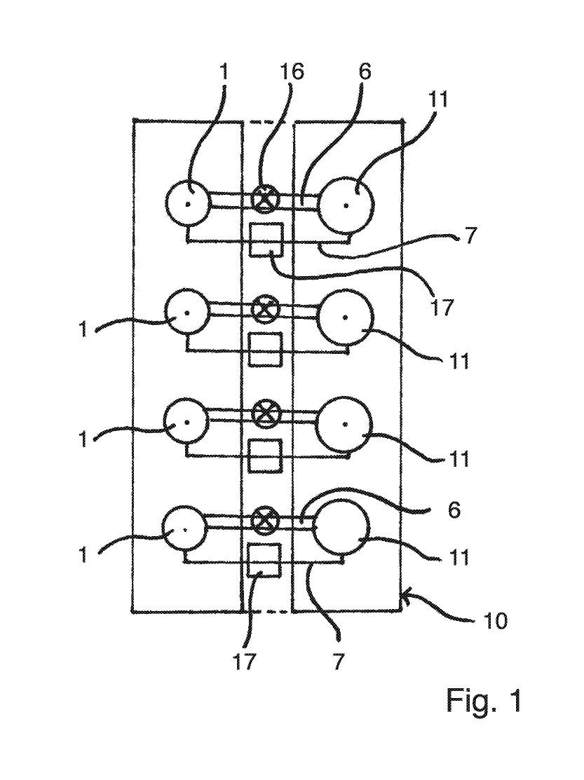

FIG. 1 shows a diagrammatic plan view of a cylinder block with a respective row of 4 indicated working cylinders and 4 subsequent cylinders respectively associated with a working cylinder,

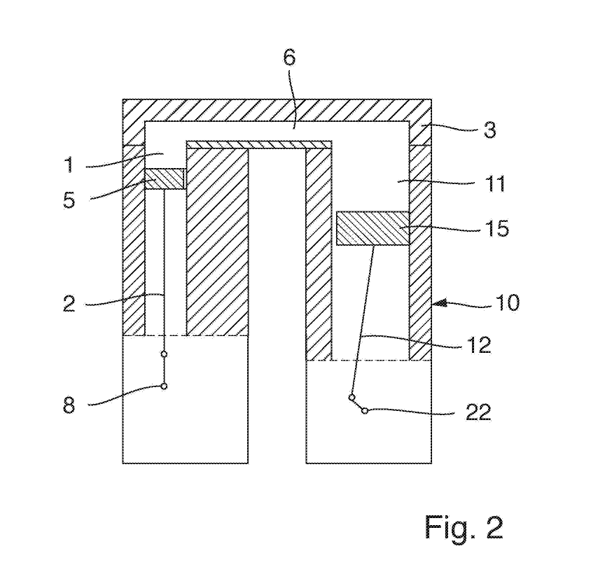

FIG. 2 shows a diagrammatic vertical sectional view through a working cylinder and an associated subsequent cylinder,

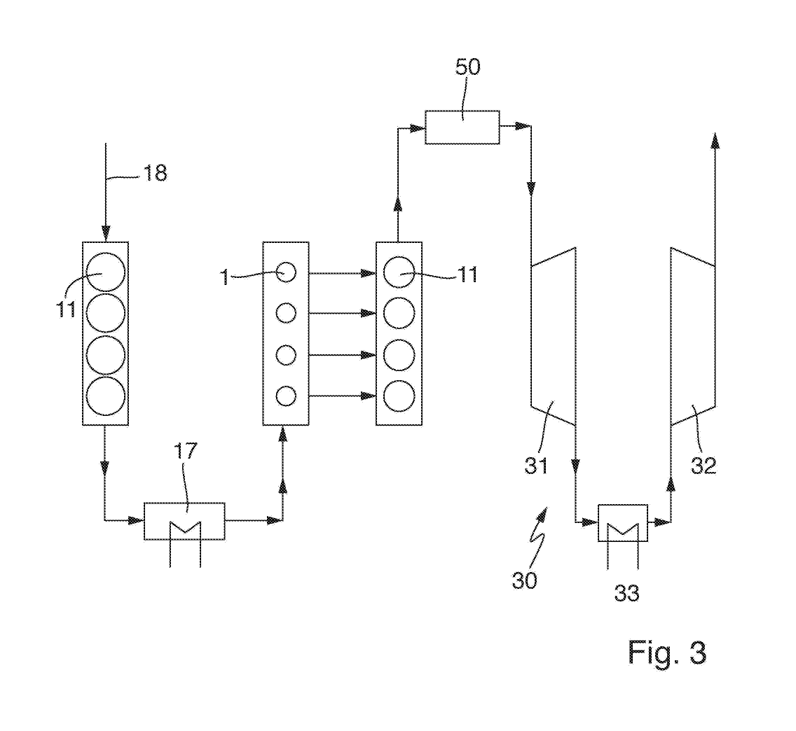

FIG. 3 shows a flow chart illustrating the path of the combustion air through a subsequent cylinder to the outlet of an inverse turbine,

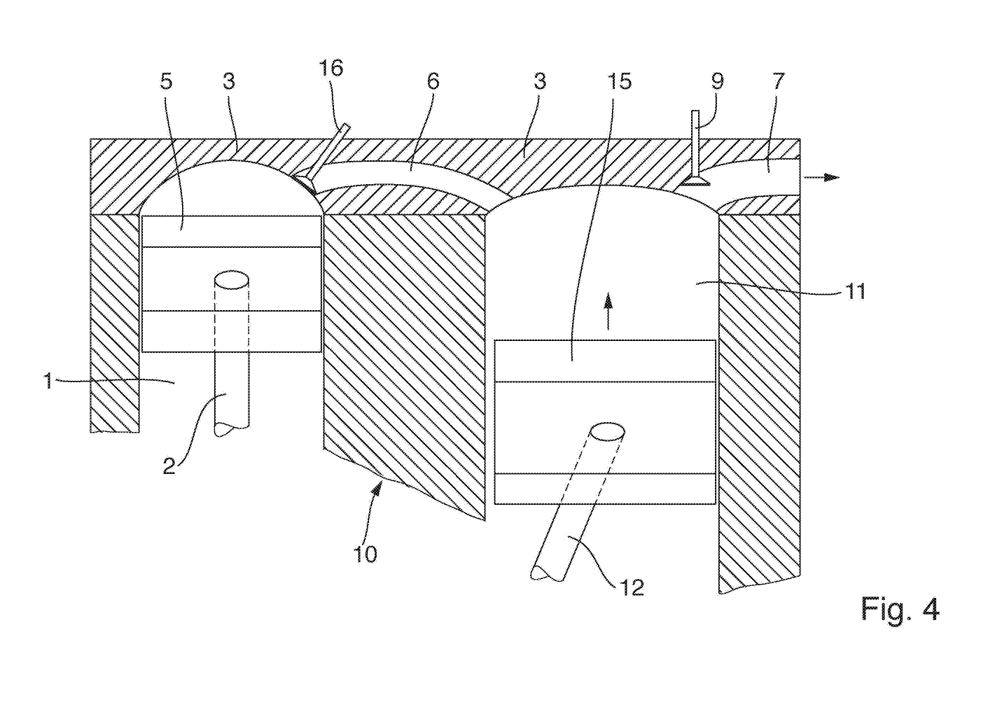

FIG. 4 shows a snapshot at the beginning of the working stroke of the working cylinder with a trailing subsequent cylinder which expels pre-compressed air to an intercooler 17, and

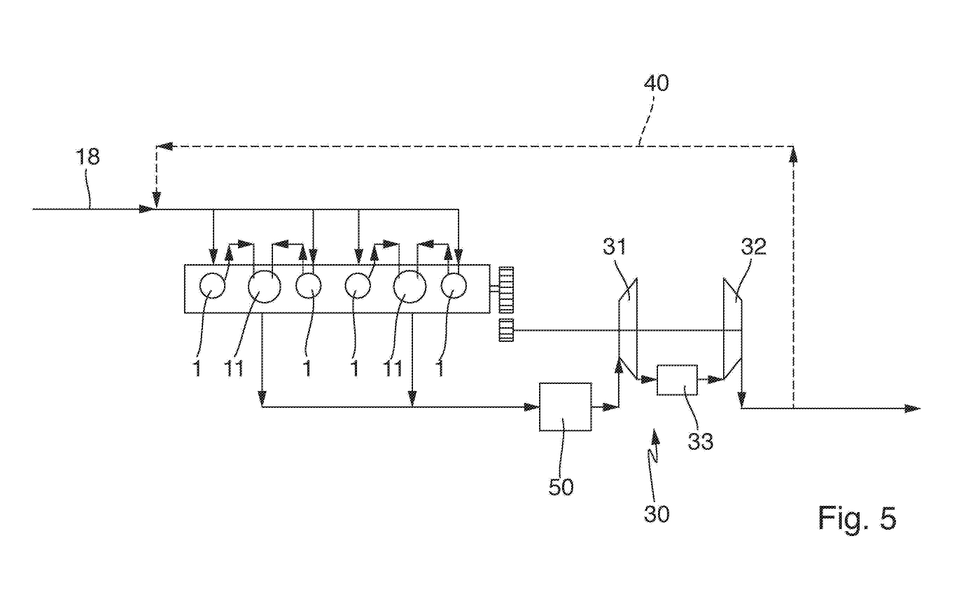

FIG. 5 shows an alternative flow chart with subsequent cylinders in the form of a two-stroke.

The diagrammatic plan view in FIG. 1 shows an engine block 10 having a row of four working cylinders 1 and four subsequent cylinders 11 respectively, wherein a respective working cylinder 1 is coupled to a subsequent cylinder 11, more specifically therefore being connected together by way of valves 16, 9 and corresponding transfer conduits 6, 7. In a compression stroke the subsequent cylinder is connected by way of the connection 7 to an intercooler 17 from where pre-compressed combustion air is passed to the associated working cylinder 1. In the course of a working stroke of the cylinder 1 the connection is made by way of the valve 16 to the subsequent cylinder 11 which in a working stroke delivers corresponding power by way of the crankrod 12 to a second crankshaft 22 while the working cylinder 1 drives a crankshaft 8 by way of the connecting rod 2. The crankshafts 8, 22 are preferably coupled together adjustably by way of a transmission (not shown) so that the stroke movements of the working cylinder or cylinders 1 and the subsequent cylinder or cylinders 11 are respectively in fixed but optionally adjustable relationship. After the exhaust gas expulsion stroke of the subsequent cylinder 1 the latter can again draw in air and then compress it (see also FIG. 2).

In this arrangement the subsequent cylinders 11 are of a larger diameter and a larger volume than the working cylinders 1. FIG. 2 shows substantially a longitudinal section through a working cylinder 1 and an associated subsequent cylinder 11, but not all valves and conduits are illustrated here.

FIG. 4 is once again an enlarged sectional view of a portion from an engine block 10 with a cylinder head 3. This portion includes a working cylinder 1 and an adjacent subsequent cylinder 11, wherein the mode of operation of the working cylinder 1 and the subsequent cylinder 11 is described in greater detail hereinafter. FIG. 4 shows a moment in the second working stroke of the subsequent cylinder, that is to say the stroke in which the subsequent cylinder expels pre-compressed combustion air into an intercooler through a valve 9 (see FIG. 4). In this view the piston 5 of the working cylinder 1 is in the region of its top dead center with maximum compression of the gas contained therein and begins (optionally after the injection of fuel) then to perform a working stroke with expansion of the burning fuel-air mixture.

After firing of a fuel-air mixture in the working cylinder 1 the piston of the working cylinder moves downwardly while the fuel-air mixture burns and generates a corresponding pressure. As soon as the piston of the working cylinder 1 has moved away from the top dead center by between 30° and 60°, the valve 16 is opened to the subsequent cylinder whose outlet valve 9 is then closed so that the hot combustion gases in the working cylinder also pass into the subsequent cylinder 11 and drive the piston 15 of the subsequent cylinder, that is to say they move it downwardly in FIGS. 2 and 4.

When the subsequent cylinder has reached its bottom dead center the valve 16 is closed and a further exhaust gas valve (not shown) of the subsequent cylinder is opened so that, in the renewed upward movement of the piston 15 of the subsequent cylinder 11, the exhaust gas is expelled. The piston 5 of the working cylinder 1, that leads in relation to the piston 15, then moves downwardly again in the third stroke and in so doing receives pre-compressed combustion air from the intercooler 17. The piston 15 of the subsequent cylinder 11, which follows with a certain delay, draws in combustion air or fresh air in its next stroke after closing and opening of corresponding valves.

After the piston 5 of the working cylinder 1 has moved beyond the bottom dead center it compresses the introduced (pre-compressed) air or a corresponding fuel-air mixture, in which case fuel is optionally also injected only upon or shortly before reaching the top dead center in the region of the cylinder head 3. The piston 15 of the subsequent cylinder 11, with the valve 9 closed, then compresses the combustion air which has been previously drawn in, and pushes it then into an intercooler 17 (see FIGS. 1 and 3) and thereafter the same process can be repeated with the downward movement of the piston 5 in the working cylinder 11 after moving beyond the dead center point and firing of the mixture.

FIG. 3 shows a flow chart for the engine according to the invention wherein the row of subsequent cylinders 11 is shown here on the one hand before and on the other hand after the row of working cylinders 1 only to illustrate the sequence of the flow chart and the individual strokes. It will further be appreciated that for reasons of simplification in the drawing only the path by way of the intercooler 17 is shown, while in actual fact pre-compressed air is transferred from each of the subsequent cylinders 11 by way of a cooler 17 and from there into an associated working cylinder. The intercooler 17 however can be a cooler which is used jointly by all subsequent cylinders 11 on the transfer path from a subsequent cylinder 11 to a working cylinder.

The fresh air feed 18 is implemented into a subsequent cylinder 11 where the fresh air is pre-compressed and cooled in a cooler 17. The pre-compressed cooled fresh air is fed to a working cylinder 1 where the described working stroke is then performed, in which the subsequent cylinder 11 is also again involved, being the same subsequent cylinder 11 which has previously drawn in and compressed the fresh air in another stroke.

After the subsequent cylinder has performed the corresponding working stroke the exhaust gas which has expanded almost to the ambient pressure in the subsequent cylinder 11 is passed by way of a catalytic converter 50 to an inverse turbine 30 whose inlet stage 31 is an expansion stage which is connected downstream of the intercooler 33. This provides that expansion takes place to a level below the ambient pressure so that then compression to ambient pressure takes place again in the compressor stage 32. By virtue of expansion and intermediate cooling kinetic energy can additionally be obtained from the thermal energy contained in the exhaust gas by the turbine 30. By virtue of the intermediate cooling action the compression work in the compressor stage 32 is less than the energy obtained by expansion and cooling in the expansion stage 31.

FIG. 5 shows a similar flow chart of a simple variant, wherein the subsequent cylinders are here in the form of a two-stroke so that each subsequent cylinder can respectively alternately supply two working cylinders of a four-stroke engine with pre-compressed air and can be driven by the exhaust gas pressure of the working cylinders. The flow of the working and exhaust gases is indicated by corresponding arrows. True intercooling is not provided here, but is at least partially also already implemented by the discharge of heat in the subsequent cylinder and during transfer of the pre-compressed combustion air to the working cylinder. In addition to the flow chart similarly to FIG. 3 however FIG. 5 also shows an exhaust gas recirculation means 40 which takes place at the outlet of the compressor 32 to the fresh air feed 18.

It will be appreciated that the exhaust gas recirculation can also be implemented in other engine variants according to the invention and provides generally for improved stoichiometric combustion for reducing exhaust emissions with a lower energy input.

By virtue of the better utilization of energy in all variants the working cylinders 1 can be comparatively small so that the total of the volumes of working cylinder 1 and subsequent cylinder 11 occupies at least approximately the same volume as a conventional working cylinder (with the same overall power).

The higher compression ratio and the prolonged expansion under approximately isothermal conditions and expansion to the ambient pressure improves the energy yield which can be still further increased by an inverse turbine which utilizes the residual heat of the exhaust gas.

1. An engine comprising at least one working cylinder (1) which has valves (16) and/or nozzles for the feed or injection of fuel and air and for the outlet of exhaust gas, characterised in that each working cylinder (1) is coupled to a subsequent cylinder (11) the subsequent cylinder being driven by the pressure of hot exhaust gases from the working cylinder (1) and the subsequent cylinder being so designed and arranged that on the other hand the subsequent cylinder feeds pre-compressed combustion air to the working cylinder (1), a cooling device (17) which cools the pre-compressed gas, a device (9, 7) for transferring the cooled pre-compressed gas into the working cylinder (1) and a transfer valve (16) which for a further stroke of the subsequent cylinder (1) transfers exhaust gas under pressure from the working cylinder (1) into the subsequent cylinder (11).

2. An engine as set forth in claim 1 characterised in that the subsequent cylinder is of a larger volume than the working cylinder.

3. An engine as set forth in claim 2 characterised in that the volume of the subsequent cylinder is between 1.2 and 4 times the volume of the working cylinder.

4. An engine as set forth in claim 1 characterised in that the compression ratio (ϵ) of the subsequent cylinder is between 2 and 5.

5. An engine as set forth in claim 1 characterised in that an intercooler is provided between the outlet of the subsequent cylinder and the inlet of the working cylinder.

6. An engine as set forth in claim 1 characterised in that disposed downstream of the subsequent cylinder is an inverse turbine having an inlet stage for expansion under ambient pressure, an intercooler connected downstream of the inlet stage and a compression stage for concluding compression to ambient pressure as the outlet stage.

7. An engine as set forth in claim 1 characterised in that the engine has an exhaust gas recirculation means.

8. An engine as set forth in claim 1 characterised in that it is in the form of a four cylinder engine with respectively four working cylinders and four subsequent cylinders and two crankshafts (8, 22), of which one is associated with the working cylinders and the other with the subsequent cylinders.

9. A engine as set forth in claim 1 characterised in that the crankshafts (8, 22) are adjustably coupled together.

10. An engine as set forth in claim 1 characterised in that the compression ratio of the working cylinder is between 6 and 10.

11. An engine as set forth in claim 1 characterised in that the cylinders are arranged in a V-shape, wherein one bank of the V-shape is formed by the working cylinders and the other bank of the V-shape is formed by the subsequent cylinders.

12. An engine as set forth in claim 1 characterised in that the subsequent cylinder or cylinders are in the form of a 4-stroke cylinder.

13. An engine as set forth in claim 1 characterised in that the subsequent cylinder or cylinders are in the form of 2-stroke cylinders, wherein the number of subsequent cylinders is half the number of working cylinders and each subsequent cylinder is associated with two different working cylinders, the working strokes of which are displaced relative to each other substantially through 180°.

14. A method of operating an engine as set forth in claim 1 in which in a first stroke of a subsequent cylinder (11) ambient air is drawn in, in a second stroke it is compressed and after intercooling it is transferred to a working cylinder (1), wherein after or during a corresponding working stroke of the working cylinder (1) the exhaust gas of the working cylinder, that is under residual pressure is transferred to the subsequent cylinder (11) which in a third stroke receives the hot exhaust gas, relieves its pressure and in a fourth stroke of the subsequent cylinder (11) ejects it with a reduced residual pressure.

15. A method as set forth in claim 14 characterised in that the reduced pressure at the outlet of the subsequent cylinder approximately corresponds to the ambient pressure.

16. A method as set forth in claim 14 characterised in that the waste heat of the exhaust gas ejected from the subsequent cylinder is converted into mechanical work by an inverse turbine.

17. A method as set forth in claim 14 characterised in that the gas-fuel mixture in the working cylinder is fired later than 30°, preferably later than 25° and up to 10° particularly preferably between 20° and 10°, before the top dead center.

18. A method as set forth in claim 14 characterised in that the combustion chamber of the working cylinder is connected to the working volume of the subsequent cylinder in a range of between 30° and 60° after the top dead center.
